(19) United States
(12) Patent Application Publication
(10) Pub. No.: US 2010/0293046 A1
(43) Pub. Date: Nov. 18, 2010

(54) SYSTEM AND METHOD FOR OPTIMIZING DELIVERY OF INVENTORY FOR ONLINE DISPLAY ADVERTISING

(76) Inventors: Raymond Mark Cooke, El Granada, CA (US); Madhu Vudali, Santa Clara, CA (US)

Correspondence Address: COOLEY LLP;ATTN: Patent Group, Suite 1100, 777 - 6th Street, NW, WASHINGTON, DC, 20001, US

(21) Appl. No.: 12/780,842

(22) Filed: May 14, 2010

Related U.S. Application Data
(60) Provisional application No. 61/178,132, filed on May 14, 2009.

(51) Int. Cl. G06Q 30/00

(52) U.S. Cl. 705/14.42

(57) ABSTRACT

An ad network system for optimizing the delivery of online display advertisement inventory is disclosed. The ad network system includes an advertiser management system to manage and acquire data for a set of advertising campaigns for a set of advertisers and a publisher management system to manage and acquire data for inventory at publishers' sites and applications. A delivery management system manages representations of the set of advertising campaigns in a third-party, external ad server in order to meet a set of guarantees for the set of advertising campaigns.

### CROSS-REFERENCE TO RELATED APPLICATIONS

This application claims the benefit of U.S. Provisional Application No. 61/178,132, filed May 14, 2009, entitled “System and Method for Optimizing Delivery for Online Display Advertising”, which is incorporated herein by reference in its entirety.

### BRIEF DESCRIPTION OF THE INVENTION

This invention relates generally to online display advertising. More particularly, this invention relates to techniques for creating, monitoring, and controlling the representation of guaranteed advertising campaigns managed by an ad network with the use of an external, third-party ad server.

### BACKGROUND OF THE INVENTION

Online display advertising is a popular form of advertising on the Internet that enables advertisers to communicate messages to their target audiences at an affordable cost. The advertiser's messages are communicated online via what's commonly referred to as “display ads”. Display ads may contain text, pictures, audio, video, or a combination of various types of media and interactive content. They may come in many forms and sizes and appear on web pages, search results, e-mails, text messages, online games, social network sites, and a host of other applications.

The multitude of sites on the Internet provides a thriving market for display ads. Participants in the market include advertisers, publishers, and users. The advertisers create the ads (sometimes with help from advertising agencies), and the publishers display the ads—along with content—to the users. By offering content that tends to cater to specific interests and demographics, the publishers enable advertisers to reach their target audience efficiently and effectively.

The advertisers' goal is to deliver a marketing message to their target audience, be it for brand awareness, to develop an emotional connection with the audience, to drive local sales, or for online conversion. For example, a car company may have display ads to build its brand around trust and safety, a pharmaceutical company may have display ads to market a certain drug using patients' stories, and a software company may have a display ad to convert users into buying a particular product.

Publishers, on the other hand, are concerned about growing their user base, page views (such as through repeat visits), and engagement with their users. They do so through organic growth due to their online brand (e.g., popular sites such as CNN.com, NYT.com, facebook, etc.), by producing and publishing original content that attracts users, and by optimizing the placement of their sites in search engine results.

Publishers may also obtain revenue for their content by charging subscription fees to users or offering ad space to advertisers. Ultimately, users want to consume relevant, interesting content, find the information that would help them make a decision, and/or purchase goods and services online. With this in mind, publishers aim to display ads that are relevant and interesting to users and that lead to higher click-through rates, i.e., to higher user clicks on any given ad.

Publishers typically do not serve all the ads to the users themselves, but instead, rely on “advertising networks” to help with monetizing inventory that they cannot sell directly to advertisers. An ad network serves as an intermediary between publishers and advertisers to connect publishers that want to host ads to advertisers who want to run the ads. The ad network buys ad space or inventory from multiple publishers and re-sells them to the advertisers. The inventory may be in the form of “impressions”, which are defined as the display of advertising units on content requested by a user. Examples of ad networks include Doubleclick.com, Brand.net, and those offered by Google and Yahoo!, among others.

An ad network therefore provides advertisers a “one-stop shop” where they can get the benefits of online display advertising, while avoiding the costs of having to negotiate deals with a large number of publishers individually. The ad network may offer advertisers the ability to run “advertising campaigns” while providing guarantees such as a guaranteed total number of impressions delivered over a given time period (or “flight”), with a desired mix of different site categories (or “channels”, such as “e-mail”, “sports”, and “lifestyles—women”, among others), and with a number of campaign goals, such as in the form of a lower bound on the number of impressions or unique users that meet some specified criteria.

The ad network should not only ensure that the contractually guaranteed impression totals are delivered for a given advertising campaign, but also that other advertising campaign constraints specified by the advertisers are observed, including channel mix, smooth pacing or delivery over time, and audience segmentation (or “targeting”). For example, an advertising campaign may require that some fraction of all delivered impressions be from a given audience segment, e.g., “females—age 25-44”, that a certain number of unique users be reached, or that at least 20% of impressions come from sports channels. The ad network can also add value by ensuring impression delivery, quality standards, and other campaign performance metrics that may be of interest to the advertiser.

Meeting these advertising campaign guarantees is complicated by the fact that ad delivery in an ad network is often managed by external, third-party ad servers, such as those offered by Doubleclick.com and Adtech.com. When a request for an ad is made on a publisher's site or application, the request is often made to one of those external ad servers that matches the request to an ad. The external ad server makes the real time decisions about how the actual ad delivery is performed, without considering the requirements and desired guarantees of the advertising campaigns managed by the ad network.

In order to bridge the gap between the ads delivered by the external ad server and the fulfillment of advertising campaign guarantees, every campaign may require a “representation” in the external ad server. Each representation can be thought of as a set of bookings made in the external ad server with appropriate settings and assignments, configured so that the matching of ad requests to the bookings is as close as possible to the desired behavior of fulfilling the campaign guarantees.

A typical feature of commonly used external, third-party ad servers is that these bookings are considered to be independent of each other. Prioritization or conditional behavior within a booking is also not supported. As a result, advertising networks are faced with the problem of defining and controlling these representations. Representations that allow fine grained control are larger and more difficult to manage, while broader ones may make it harder to meet campaign guarantees and goals.

Further, it can be challenging to define and control representations because different campaigns may use the same inventory, creating network effects that cannot be easily modeled. In addition, the supply of impressions from publishers tends to be very volatile, leading to representations having to be frequently updated in response to newly observed publisher data and behavior. This is currently done by manual, direct user interaction with the external ad servers, which often results in a failure to meet campaign requirements.

Accordingly, it would be desirable to provide a system and method for ad networks to create, monitor, and control the representations of guaranteed advertising campaigns in an external, third-party ad server.

### SUMMARY

An ad network system optimizes the delivery of online display advertisement inventory. The ad network system includes an advertiser management system to manage and acquire data for a set of advertising campaigns for a set of advertisers and a publisher management system to manage and acquire data for inventory at publishers' sites and applications. A delivery management system manages representations of the set of advertising campaigns in a third-party, external ad server in order to meet a set of guarantees for the set of advertising campaigns.

An embodiment of the invention includes a method for optimizing the delivery of online display advertising in an ad network system using a third-party, external ad server to serve ads. Data is acquired for a set of advertising campaigns managed by the ad network system and for publishers' sites and applications in the ad network system. A set of representations is maintained for the set of advertising campaigns in the third-party, external ad server. An allocation of ads to the set of representations is determined. The set of representations is updated to meet a set of guarantees for the set of advertising campaigns.

### BRIEF DESCRIPTION OF THE DRAWINGS

Embodiments of the invention are more fully appreciated in connection with the following detailed description taken in conjunction with the accompanying drawings, in which like reference characters refer to like parts throughout, and in which:

FIG. 1 illustrates an exemplary environment in which an ad network operates;

FIG. 2 illustrates a schematic diagram of exemplary advertising campaigns in accordance with an embodiment of the invention;

FIG. 3 illustrates a more detailed ecosystem in which an ad network operates in accordance with an embodiment of the invention;

FIG. 4 illustrates a schematic diagram of the operation of the Delivery Management System of FIG. 3 in accordance with an embodiment of the invention;

FIG. 5 illustrates a schematic diagram of the relationships between the advertising campaigns and the representations in third-party ad server of FIG. 3 in accordance with an embodiment of the invention;

FIG. 6 illustrates a schematic diagram of the state transformation process in Delivery Management System of FIG. 3 in accordance with an embodiment of the invention;

FIG. 7 illustrates a schematic diagram of the evaluation of potential allocation sets in accordance with an embodiment of the invention;

FIG. 8 illustrates a flow chart for an exemplary optimization to determine an optimal allocation of available impressions to advertising campaign representations in accordance with an embodiment of the invention; and

FIG. 9 illustrates a computer system for implementing the embodiments of the invention.

### DETAILED DESCRIPTION

A system and method for optimizing the delivery of inventory for online display advertising is provided. As generally used herein, a display advertisement or “display ad” may be any ad containing text, pictures, audio, video, or a combination of various types of media and interactive content for online display. Display ads may have many forms and sizes and appear on various sites and applications, such as web pages, search results, e-mails, text messages, online games, social network sites, and a host of other applications. The ads are created by advertisers and publishers display the ads—along with content—to users.

According to an embodiment of the invention, an ad network serves display ads to publishers to satisfy one or more advertising campaigns for one or more advertisers. The advertising campaigns are specified by a set of guarantees delivered over a given period of time (or “flight”) and subject to a set of qualifiers, constraints, quality controls, and business rules imposed by the advertisers. The guarantees may include a total number of impressions during the flight period or any other performance metric for delivering ads that may be of interest to the advertisers.

An impression, as generally referred to herein, is the display of an ad to a user in a publisher's site or application. Impressions may be purchased in bulk via ad calls or ad requests on a publisher's application, e.g., IM, e-mail, search engine, etc., or on a web browser. Each impression has a set of attributes that depends on the publisher, the specific nature of the purchase, and user information either present in a given ad call or decoded from it.

In one embodiment, impression attributes may be classified as declared, inferred and modeled. Declared attributes are specified in a purchase and correspond to dimensions that a publisher's ad server can distinguish but the ad server used by the control system cannot. For example, a publisher may use registration information present in a web browser cookie in order to distinguish the gender of a user on the site. Inferred attributes are detectable for any impression request, regardless of the publisher from which it came. An example is a geographical categorization based on the IP address associated with the impression request. Another case involves situations where the publisher inventory is purchased generically, for example, as part of a channel containing related websites, and the ad server uses the Internet domain associated with the request to determine what site it is coming from. Modeled attributes are not known for each impression request but only known in aggregate based solely on external details about the publisher, incorporating any constraining details present in the purchase.

Campaign qualifiers may include any designation that describes or qualify the ads in the campaign, such as, for example, the type of product advertised, a price for the product, an age-specific recommendation for the product, a gender recommendation for the product, and so on. Campaign constraints may include a specified set of channels, audience segment, geographic segment, and so on. And quality controls may include any restriction on objectionable or other undesirable content present in publishers' sites and applications.

In one embodiment, the constraints, qualifiers, quality controls, goals, and other requirements and features of a given campaign are used as inputs into a delivery management system in an ad network in order to manage the delivery of ads in an external, third-party ad server and fulfill the campaign guarantees. The delivery management system uses the inputs from the advertising campaigns to create, monitor, and control a set of campaign representations in the external ad server. Representations, as generally used herein, are bookings made in the external ad server with appropriate settings and assignments, configured so that the matching of impression requests to the bookings is as close as possible to the desired behavior of fulfilling the campaign guarantees.

As described in more detail herein below, an optimization module is used to determine an optimized allocation of available impressions to the campaign representations. The optimization module optimizes multiple campaigns simultaneously, allows flexible specification of various business rules and performance objectives, and balances a large number of goals in a highly uncertain environment.

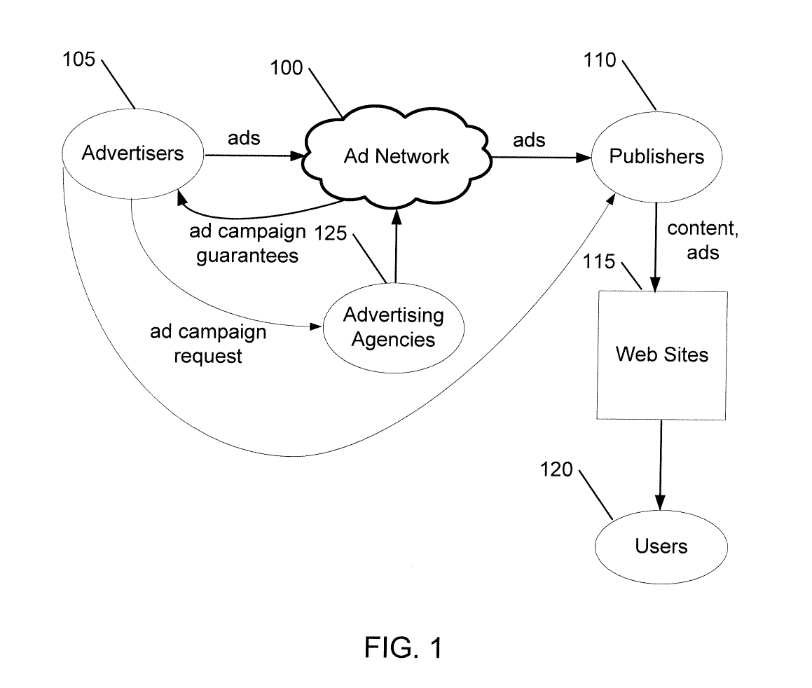

Referring now to FIG. 1, an exemplary environment in which an ad network operates is described. Ad network system 100 is an intermediary network between a set of advertisers 105 and a set of publishers 110. Advertisers 105 engage ad network system 100 to run advertisement campaigns online by serving display ads to sites and applications operated by publishers 110, such as web pages (e.g., web pages 115), search engines, e-mails, text messages, online games, social network sites, and so on, that are viewed by users 120. Advertisers 105 may create the ads themselves and provide them to ad network system 100, or they may interact with one or more advertising agencies 125 to manage their advertisement campaigns and create ads that most effectively achieve their marketing goals.

When advertisers 105 engage ad network system 100 to run their advertisement campaigns, advertisers 105 may require ad network system 100 to abide by a set of campaign guarantees. Such guarantees may include, for example, a total number of impressions (or other performance metric) delivered over a flight period, with a desired mix of channels, with a specified pacing of delivery during the flight period, and for a particular audience segment. Advertisers 105 may also require that ad network system 100 run their advertisement campaigns according to a set of campaign qualifiers, constraints, and quality controls.

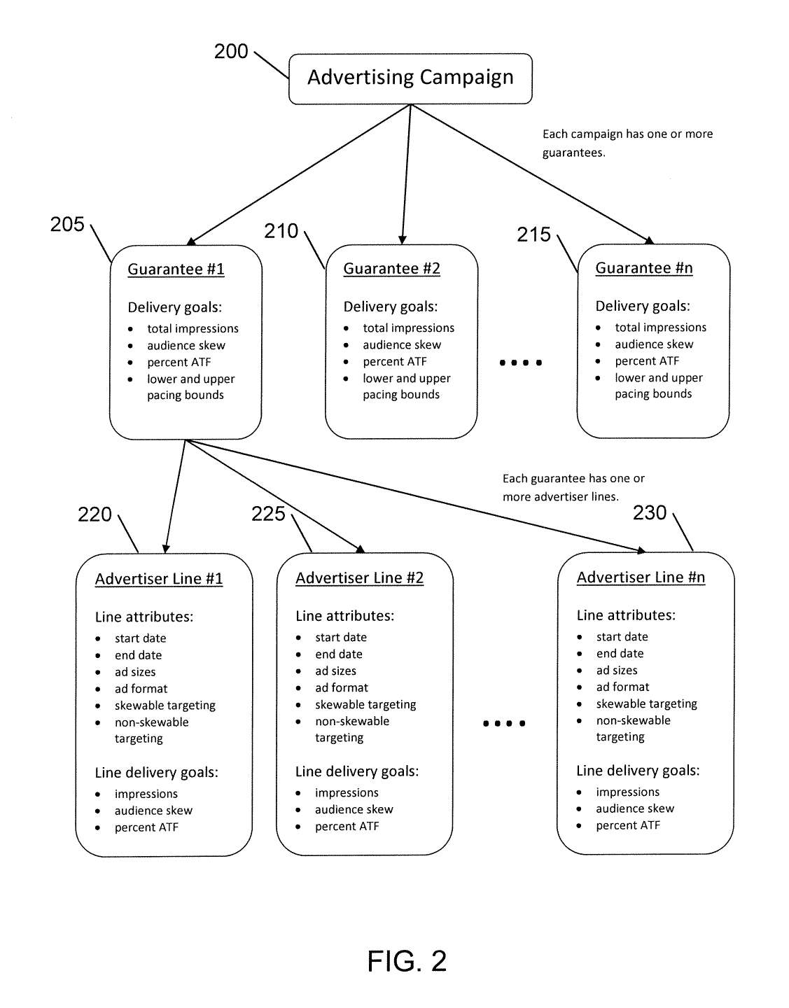

In one embodiment, advertising campaigns can be broken into one or more sets of impression targets, or guarantees, as illustrated in FIG. 2. Advertising campaign 200 may be segmented into multiple campaign guarantee groups 205-215, which, in turn, can be segmented into multiple advertiser lines 220-230. Each advertiser line specifies a set of attributes, such as a start and an end date for running the campaign, an ad format, and an associated channel, among others. For example, a November-December advertising campaign may have three separate impression guarantee groups—one for each month. Alternatively, a campaign may have one guarantee for one ad format (e.g. standard banner), and another guarantee for a different ad format (e.g. expandable banner).

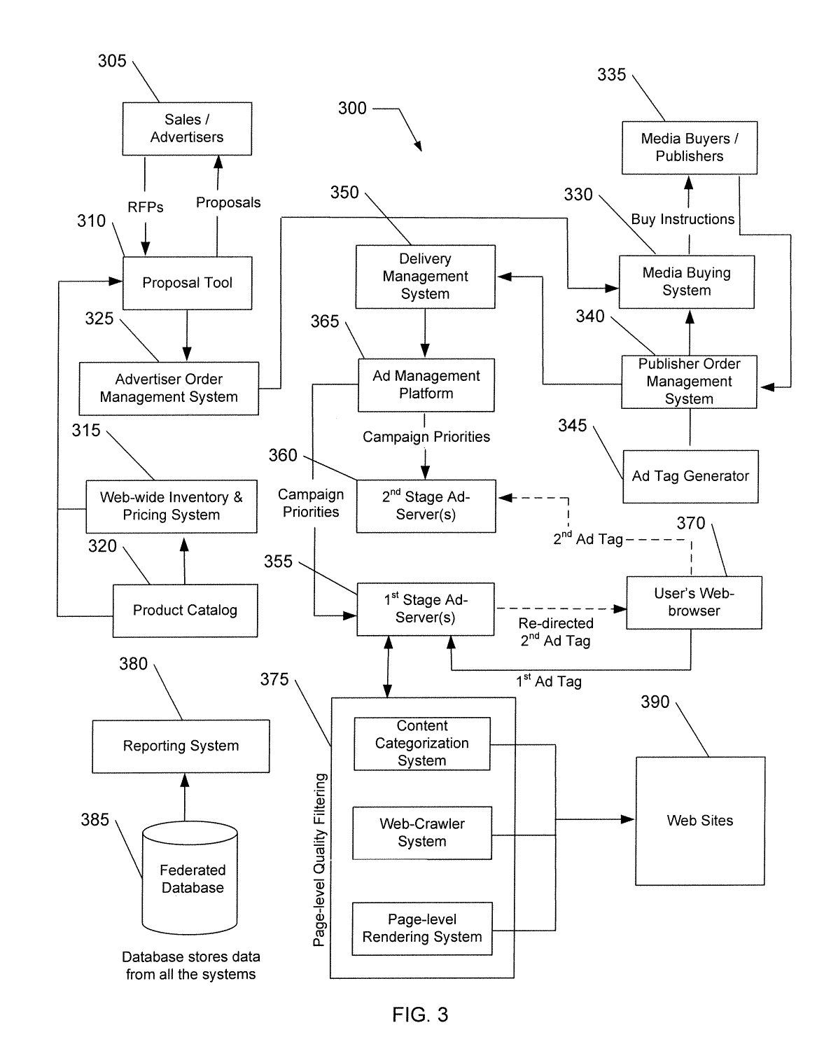

FIG. 3 illustrates a more detailed ecosystem in which an ad network system operates in accordance with an embodiment of the invention. Advertisers 305 may submit requests for proposals, or “RFPs”, to ad network system 300 to run one or more advertising campaigns for them. The RFPs are sent to Proposal Tool 310, which is a special purpose computer server for creating proposals for advertisement campaigns. Proposal tool 310 submits the proposals to advertisers 305, specifying to advertisers 305 the campaign guarantees, constraints, and quality controls for each campaign.

In doing so, Proposal Tool 310 also checks Inventory and Pricing System 315 to forecast the availability of inventory (i.e., impressions on publisher's sites and applications) and an appropriate pricing structure for fulfilling a given advertising proposal for a given advertising campaign. The inventory and pricing forecast may be determined based on the quality controls specified in the proposal for the campaign and according to Product Catalog 320, which defines the ads being sold by ad network system 300 to advertisers 305, specifying the available channels, the targeting criteria (e.g., demographic, geographic, and temporal), as well as the sizes (e.g., 728×900, 300×250 etc.) and formats (e.g., standard, rich media, video) of the ads. As understood by those skilled in the art, the pricing structure may be based on measures such as cost per impression (e.g., cost per a thousand impressions, or “CPM”), cost per click through, cost per action, cost per sale, or any other online advertising pricing model.

The advertising campaigns are managed by Advertiser Order Management System 325, which is a special purpose computer server for managing the campaigns during their delivery to publishers. All campaign qualifiers, constraints, and quality controls are stored and maintained in this system.

Once a proposal is established for a given advertising campaign, ad network system 300, through Media Buying System 330, makes optimized purchases of ad inventory, i.e., impressions, from publishers 335. Media Buying System 330 sends purchasing instructions to publishers 335, which then engage Publisher Order Management System 340 in ad network system 300 to manage the inventory purchases. Media Buying System 330 is the subject of the commonly owned, related patent application entitled “System for Optimizing Purchase of Inventory for Online Display Advertising”, filed the same day as the present application, application Ser. No. ______, Attorney Docket No. BRAN-002/01US.

The delivery of the inventory to ad network system 300 is managed by Delivery Management System 350, which maps the impressions sold by purchasers 335 to bookings in ad servers in ad network system 300 that serve the ads to be displayed in the impressions. Delivery Management System 350, as described in more detail herein below, controls the delivery of inventory to ad network system 300 in order to meet the advertising campaign guarantees subject to its constraints, qualifiers, and guarantees, in an optimal manner.

In accordance with an embodiment of the invention, ads are served by ad network system 300 in two stages, with two dedicated ad servers. The first stage is handled by First Stage Ad Server 355 and the second stage is handled by Second Stage Ad Server 360. Second Stage Ad Server 360 may also interact with an external, third-party Ad Management Platform 365 when serving the ads, such as the Doubleclick.com or Adtech.com platforms. Ad Management Platform 365 may have multiple ad servers for serving ads to multiple publishers' sites and applications.

First Stage Ad Server 355 applies quality controls of the advertising campaigns before instructing Second Stage Ad Server 360 to serve the ads. An ad is served once a user places an ad call or ad request on a publisher's application, e.g., IM, e-mail, search engine, etc., or on a web browser, such as User's Web Browser 370. Upon receiving the ad call, First Stage Ad Server 355 sends the content of the page for analysis to Page-Level Content Categorization Module 375, which analyzes the page to determine whether it contains any objectionable or other undesirable content.

First Stage Ad Server 355 then formats an appropriate response to the publisher's page or application, which then interacts with Second Stage Ad Server 360 to determine which of the eligible campaigns can serve the ad. In doing so, Second Stage Ad Server 360 may interact with an external, third-party ad server in Ad Management Platform 375, such as Doubleclick.com or Adtech.com.

Page-Level Content Categorization Module 375, as well as the process for serving the ads, are the subject of the commonly owned, related patent application entitled “System and Method for Applying Quality Controls to Online Display Advertising”, filed the same day as the present application, application Ser. No. ______, Attorney Docket No. BRAN-003/01US.

Delivery Management System 350, as described in more detail herein below, ensures that the ad delivery made by the third-party ad server meets the guarantees of the advertising campaigns.

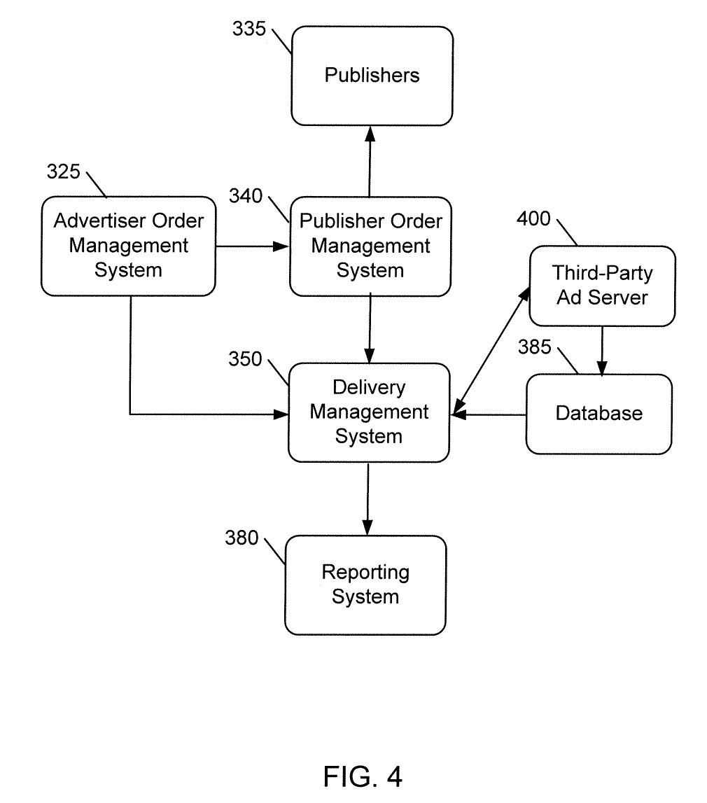

Referring now to FIG. 4, a schematic diagram illustrating the operation of Delivery Management System 350 in accordance with an embodiment of the invention is described. Delivery Management System 350 is a specially programmed machine that takes as input campaign constraints, qualifiers, quality controls, goals, and other campaign requirements and features from Advertiser Order Management System 325, as well as data describing publisher supply from Publisher Order Management System 340. Publisher Order Management System 340 also receives campaign details from Advertiser Order Management System 325 and in response makes purchases from multiple internet publishers 335 to satisfy the demand for ads by advertisers 305.

Delivery Management System 350 constructs and maintains representations of the campaigns in third-party ad server 400. In one embodiment, a representation includes an element for each separable source of impressions that contribute to different campaign goals. For example, a common goal may be channel delivery. Since a publisher's purchases typically belongs to a single channel, Delivery Management System 350 creates a representation element for each channel, and configures the element to only allow delivery from purchases within that channel. Representation elements may also be configured so that delivery can satisfy any campaign requirements, such as geographic targeting, and have date ranges and impression allocations reflecting the campaign parameters. As such, publishers 335 make impression requests to ad server 400, where, according to its internal logic, it matches the impression requests to an element, or booking, in a representation. If no eligible element can be found, a default ad may be served.

Third-party ad server 400 communicates with database 385, where details of the impression requests are stored. Delivery Management System 350 queries this database for information, and also interacts with third-party ad server 400 in order to modify representations and receive up to date data when possible. Finally, Delivery Management System 350 supplies data to reporting system 380, where users can monitor campaign delivery and details.

For every advertising campaign, Advertiser Order Management System 325 supplies a unique identifier, start and end times, a list of creatives (i.e., the words, design, and display information for an ad), the total guaranteed impressions, a partitioning of the impressions into guaranteed groups, upper and lower bounds on aggregate group delivery by date, a list of required inferable or declared impression characteristics for each group, and a list of goals based on impression characteristics (of any type) for each group. Optionally, Advertiser Order Management System 325 may also supply a prioritization of campaign goals, in the absence of which a default prioritization may be used.

Upon receipt of data from Advertiser Order Management System 325, Delivery Management System 350 creates a new representation for new campaigns and modifies existing representations for campaigns whose bookings have been altered. This process is described in more detail herein below.

Publisher Order Management System 340 supplies to Delivery Management System 350 a mapping of campaigns to publishers 335 whose impressions may be used to satisfy the campaigns. Publisher Order Management System 340 also supplies details for every purchase made. The purchase details may include a unique identifier for the publisher, a unique identifier for the purchase, the ad sizes purchased, start and end times, the total number of expected impressions and a list of declared and inferred impression characteristics used in the purchase. In addition, Publisher Order Management System 340 may provide a purchase independent description of modeled impression characteristics for each publisher 335.

Third-party ad server 400 provides Delivery Management System 350 with updated total delivery totals by representation elements. In one embodiment, this is typically available on an hourly basis. Database 385 may also provide more detailed data but is less frequently updated, usually once per day. Database 385 may supply impression level details, including a decoding of all inferred characteristics, the element chosen to satisfy the impression request (or an indicator identifying a default), the publisher identifier and, when possible, the identifier of the purchase that supplied the impression request. When the purchase identifier is not available, it can be statistically inferred from the set of eligible purchases on the publisher.

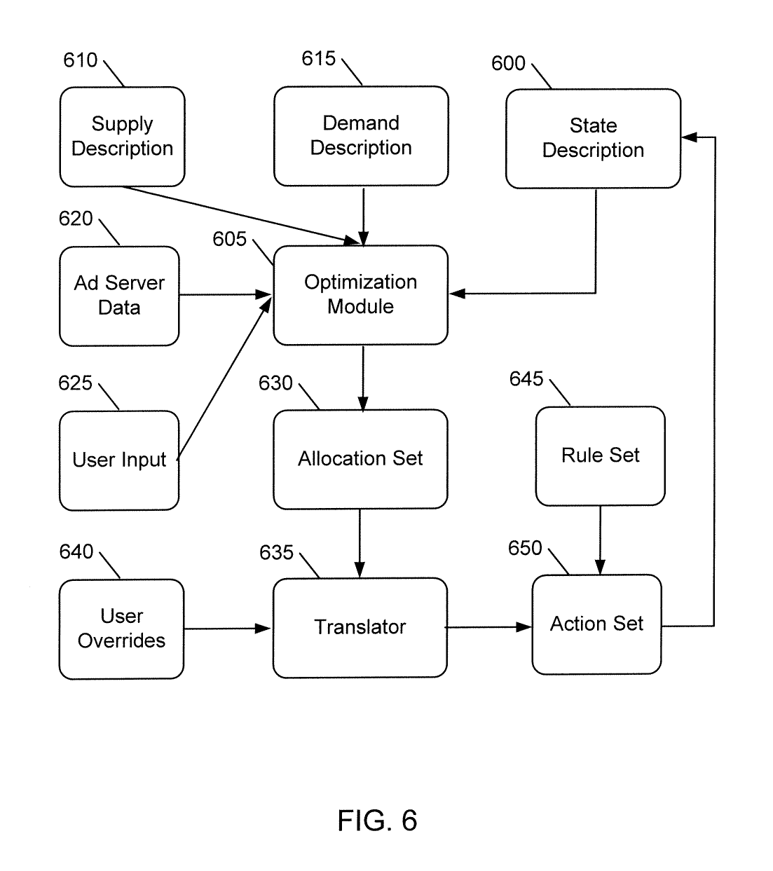

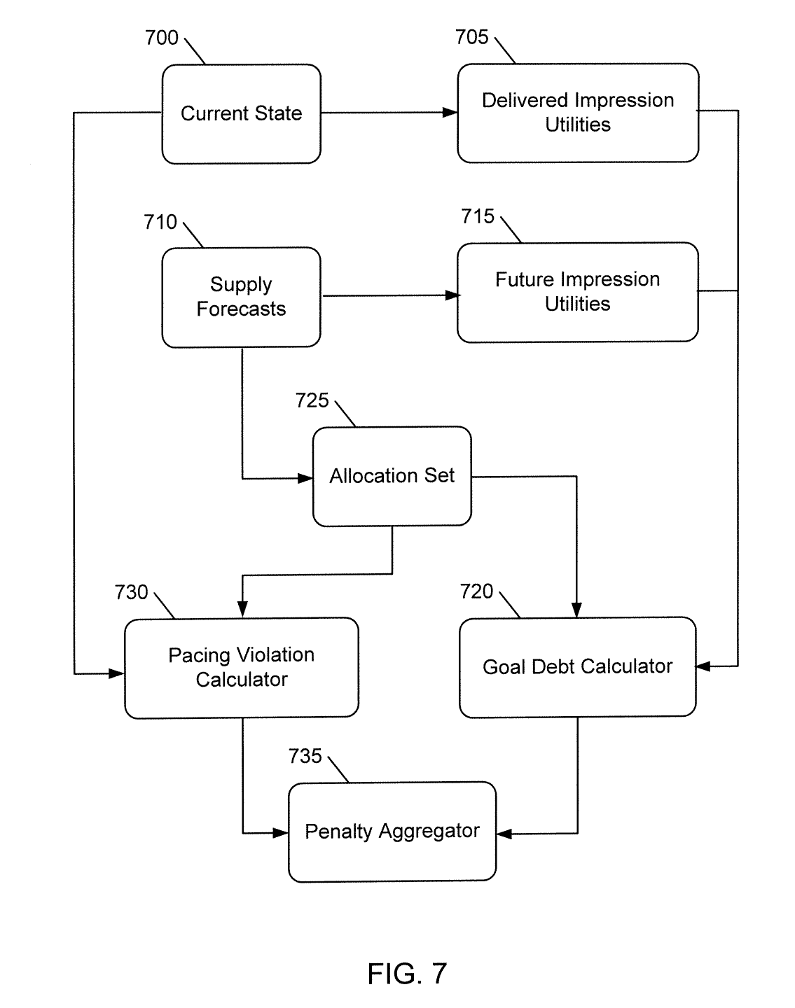

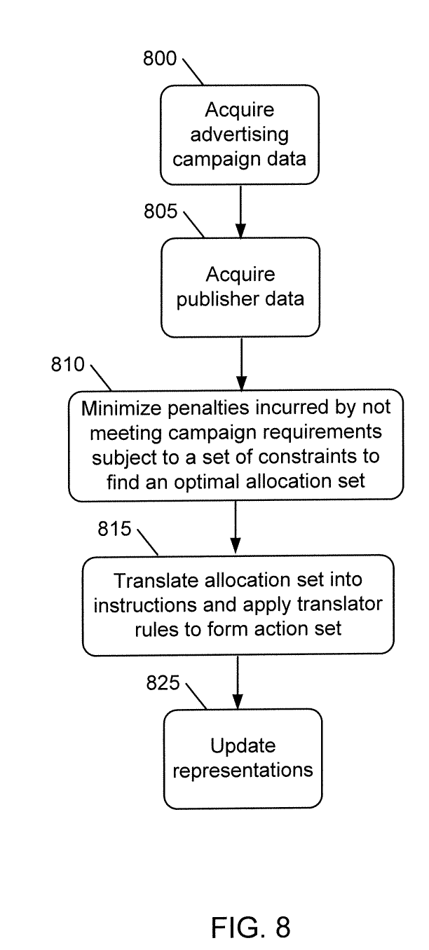

In one embodiment, Delivery Management System 350 has an internal state that is periodically transformed according to updated data obtained from Advertiser Order Management System 325, Publisher Order Management System 340, third-party ad server 400, and database 385. This process, described in more detail herein below with reference to FIG. 6, may happen according to a predetermined schedule, upon user request, or upon a predefined significant event. Fundamental to the state transformation is a mathematical optimization, described in more detail herein below with reference to FIGS. 7-8.

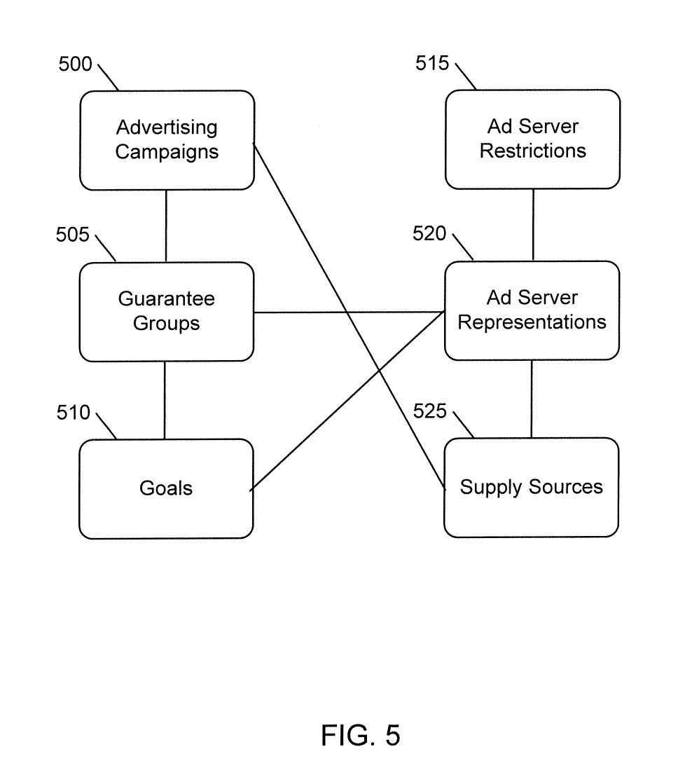

FIG. 5 illustrates the relationships between the advertising campaigns and the representations in third-party ad server 400. Third-party ad server 400 has specific restrictions 515 that may interfere with their ability to fulfill guarantees for campaigns 500. For example, a common type of restriction may be the inability of ad server 400 to have a representation element that allows delivery of ads with multiple sizes. Any campaign 500 that has a guarantee with multiple, and substitutable, ad sizes may therefore require multiple representation elements for representations 520 within ad server 400.

Another common issue is when a campaign requires certain creatives to be shown only in certain circumstances, for example, creatives specific to geographical areas. Ad server 400 does not typically allow such targeting at the creative level, but only at the booking level, so this requires additional representations to be made. Delivery Management System 350 is programmed with details of these restrictions, and combines them with the input data from Advertiser Order Management System 325 and Publisher Order Management System 340 in order to determine the needed list of representation elements.

Every guarantee group 505 produces a set of elements within which impression totals are substitutable. Delivery Management System 350 may also create elements that relate to campaign goals 510 if control at that level is warranted. In general, as the number of elements per representation increases, the level of control increases but at the expense of effectiveness. Delivery Management System 350 includes a model of this tradeoff in the optimization module described below so that appropriate representations are made for various scenarios.

Delivery Management System 350 may also set up representation elements so that ad server 400 knows what supply sources 525 (i.e., publishers' sites and applications) are eligible for what elements. It is appreciated that different types of requests may be made to different ad servers and Delivery Management System 350 creates and maintains representations based on this partitioning.

Referring now to FIG. 6, a schematic diagram illustrating the state transformation process in Delivery Management System 350 is described. Delivery Management System 350 has state description 600, which includes a description of representations 520 and their elements, a partitioning of predicted supply (i.e., impressions) and a schedule for their modification in the future. According to one embodiment, representations 520 can be modified even if new data is not available. Optimization module 605 in Delivery Management System 350 takes into account the existing state description 600, an updated supply description 610, an updated demand description 615, data 620 from ad server 400, and user input 625.

Updated supply description 615 is based on the purchase information and combined with historical delivery from database 385 to construct a statistical forecast of expected future impressions by purchase, ad size and combination of inferred characteristics for every day left in the purchase. The forecast is assumed to include a point estimate as well as an estimate of the variance in the forecast. If variance is unavailable, then point estimates may be used. As understood by one skilled in the art, the forecasts may be determined with any standard time series technique.

Updated demand description 615 may include specifications, qualifiers, constraints, goals, and quality controls for campaigns 500 and is combined with delivery data from database 385 in order to construct the remaining debt for every campaign goal and guarantee. Optimization module 605 also takes user input 625, where a user may direct optimization module 605 to prioritize specific campaigns or goals or to exclude a campaign from the optimization process.

As described in more detail herein below, optimization module 605 evaluates potential allocation sets 630 and chooses one that minimizes a numerical objective value calculated based on the allocation set and input. Once an optimal allocation set has been chosen, it is translated into actions using a translator 635. Translator 635 takes the optimal allocation set and converts it into instructions that are appropriate for the representations in ad server 400. At this stage, a user may enter overrides 640 in order to force certain behaviors. The output from translator 635 may then be combined with rule set 645 to form action set 650 that describes the changes to be made to state description 600.

The evaluation of potential allocation sets 630 entails the aggregation of estimated penalties due to expected goals or guarantee shortfalls. FIG. 7 illustrates this evaluation in accordance with an embodiment of the invention. Current state 700 of Delivery Management System 350, combined with calculated utility of delivered impressions 705 and relative to campaign goals, gives an up-to-date remaining debt for each campaign goal. Supply forecasts 710 and calculated utility of future impressions 715, relative to campaign goals, determine the degree as to which impressions delivered from a source further reduces goal debt.

Goal debt calculator 720 takes the current state of debt, along with the allocations from supply sources to the elements associated with a goal, and calculates the expected future decrease in goal debt for allocation set 725. Similarly, current state 700 and allocation set 725 give an estimate of overall impression delivery by date and are used by pacing violation calculator 730 in order to estimate the total violation incurred by pacing violations for each guarantee group.

Penalty aggregator 735 takes the goal debt and pacing violations and uses campaign specified or default penalties to construct a total numerical score that represents the quality of potential allocation set 725. As the supply forecasts are random in nature, embodiments that are able to incorporate the statistics of the forecasts in addition to their point estimates may result in different forms of the optimization objective function and constraints.

Accordingly, it is appreciated that the selection of an allocation set may be implemented by any optimization technique that is appropriate to the nature of the objective and constraint functions. An exemplary embodiment of such an optimization technique may use a linear programming model, but other types of models, such as quadratic, nonlinear or stochastic may also be used.

Referring now to FIG. 8, a flow chart for an exemplary optimization to determine an optimal allocation of available impressions to advertising campaign representations in accordance with an embodiment of the invention is described. First, advertising campaign data is acquired by Advertiser Order Management System 325 (800). The data may include, for example, information regarding the set of campaign guarantees for the advertising campaigns managed by ad network system 300, such as, for example:

1. A start date, end date and impression amount.

2. A set of advertiser lines, each of which has a desired impression allocation.

3. For each advertiser line, a set of inferred attributes required for delivery (e.g., delivery channel, geographic location, ad size(s), expandable creative, etc.)

4. For each advertiser line, a set of goals based on inferred, declared or modeled attributes (e.g. a desired demographic target or a desired average user frequency) and a per unit penalty to be incurred by failure to meet the goal.

5. For each advertiser line, a list of purchases whose inventory may be used.

6. A set of bookings in third-party ad server 400 that corresponds to the campaign guarantees. In one embodiment, each booking maps back to a single guarantee.

Next, information from Publisher Order Management System 340 regarding purchases made from publishers is acquired (805). This data may include, for example:

1. A start date, end date and impression amount.

2. Any declared and inferred attributes that correspond to those required by the advertising campaigns managed by ad network system 300, for example, purchases may be geo-targeted or have declared demographic targeting.

3. A forecast of delivery for each day in the purchase. Forecasts made for partitions of each purchase may also be included, where a partition is a combination of inferred attributes. In one embodiment, partitions may be determined by iterating over purchases and over all qualifying guarantee goals and determining distinct combinations of inferred attributes from one or more guarantees, such that, for any guarantee, a partition may be wholly usable or totally unusable. For example, let's consider the case in which a purchase has two ad sizes, namely ad size A and ad size B. Two guarantees can use this purchase, one which has ad sizes A and B, and another which has only ad size A. In this case, the partitions can be expressed in a set such as {ad size A, ad size B}. In another example, let's consider the case in which a purchase is geo-targeted to California. Three guarantees can use this purchase. One has no declared attribute targeting, one is targeted to California and the last is targeted to, say, Sacramento. In this case, the partitions can be expressed in a set such as {California but no Sacramento, Sacramento}.

4. An estimate of the contribution of each partition to each guarantee goal.

The input data collected from the advertiser side (800) and the input data collected from the publisher side (805) are then used to find an optimal allocation set to allocate ads to bookings in ad server 400 (810). The optimal allocation set, as understood by one skilled in the art, may be found with any appropriate optimization technique, such as, for example, a linear programming model.

In one exemplary embodiment, model variables (all are continuous and >=0) may include those shown in Table 1 and model parameters (i.e., coefficients into an objective function in the linear programming model) may include those shown in Table 2.

TABLE 1
Optimization model variables

| Variable | Definition |
|---|---|
| a_{pbd} | allocation for partition p, booking b and day d. |
| A_{bd} | total allocation for booking b and day d. |
| s_{gh} | Slack variable for guarantee goal g goal h. |
| u_{gd} | Under-delivery for guarantee g on day d. |
| o_{gd} | Over-delivery for guarantee g on day d. |
| f_{pd} | Filler (unallocated inventory) for partition p on day d. |

TABLE 2
Optimization model parameters

| Parameter | Definition |
|---|---|
| I_{pd} | Impression forecast for partition p and day d. |
| D_{gh} | Debt, for guarantee g, goal h. |
| P_{gh} | Penalty for guarantee g, goal h. |
| FPₚ | Filler penalty for partition p. |
| C_{pgh} | Contribution of impressions from partition p to guarantee g, |
| | goal h. |
| U_{gd} | Upper pacing limit for guarantee g, day d. |
| L_{gd} | Lower pacing limit for guarantee g, day d. |
| UP_{gd} | Penalty for over-delivery for guarantee g, day d. |
| LP_{gd} | Penalty for under-delivery for guarantee g, day d. |
| G_{g} | Total impression goal for guarantee g. |
| H_{gh} | Total goal for guarantee g, goal h. |

It is appreciated that in this exemplary optimization model, goals are considered to be an attribute of a guarantee—different guarantees may have different goals. Goals are calculated according to the latest data and may disappear from the optimization model when they are met.

For simplicity of presentation, a generic indicator function is defined as follows:

δ(g,d)=1, if guarantee g's date range includes day d; 0, otherwise; (1)

δ(p,b,d)=1; if booking b can use inventory from partition p and the date ranges for b's guarantee and p's purchase include day d; 0, otherwise. (2)

Accordingly, the optimization model is set up to minimize an objection function Z that calculates the penalties incurred by not meeting advertising campaign requirements, as follows (810):

Z=Σ_{gd}δ(g,d)UP_{gd}o_{gd}+Σ_{gd}δ(g,d)LP_{gd}u_{gd}+Σ_{gh}P_{gh}s_{gh}+Σ_{pd}δ(p,d)FP_{pd}f_{pd} (3)

In one embodiment, the total purchase cost Z in Equation (3) may be minimized subject to the following constraints:

Σ_{pbd}δ(p,b,d)a_{pbd}+δ(p,d)f_{pd}=I_{pd}, for every partition p and day d. (4)

Σ_{pbd}δ(p,b,d)C_{pgh}a_{pbd}+s_{gh}≧D_{gh}, for every guarantee g and goal h. (5)

Σ_{pb}δ(p,b,d)a_{pbd}+δ(g,d)u_{gd}≧L_{gd}, for every guarantee g and day d. (6)

Σ_{pb}δ(p,b,d)a_{pbd}−δ(g,d)o_{gd}≦U_{gd}, for every guarantee g and day d. (7)

Σ_{pb}δ(p,b,d)a_{pbd}=δ(b,d)A_{bd}, for every booking b and day d. (8)

Σ_{bd}δ(b,d)A_{bd}=G_{g}, for every guarantee g. (9)

It is appreciated that in Equation (3) above, prioritization of goals and campaigns relative to each other can be accomplished by weighting penalties appropriately.

After minimizing Z and finding an optimal allocation set, translator 635 converts the allocation set into a set of instructions or actions to be taken by ad server 400 (815). In doing so, translator 635 may apply a set of rules. For example, consider an ad server with the following restrictions:

1. Only one creative size is allowed per booking

2. Targeting, pacing and frequency controls are only available at the booking level.

3. Frequency controls only consist of frequency capping (restricting a creative from a booking to be shown no more than a specified number during a specified time period to a user, the user is identified by a browser cookie.)

4. Pacing can only be set to even delivery or ASAP. The exact definition of these constraints is known, in the form of maximum allowed delivery at any point in time given the number of impressions allocated to the booking.

5. Bookings can be prioritized relative to each other, resulting in a weighting of delivery that biases it to lines with higher priority.

6. Bookings with large allocations are given preference compared to those with lower allocations at the same level of priority.

A set of rules for translator 635 according to these restrictions may then include:

1. For every booking, set the allocation to the total allocation recommended by the optimizer.

2. For bookings that map to guarantees that are under-delivering, set pacing to ASAP.

3. For bookings that map to guarantees that are over-delivering, set pacing to even.

4. For bookings that map to guarantees that are within pacing bounds set pacing to ASAP if the allocation in less than a specified percentage of the forecast or if expected filler is greater than a specified percentage of the forecast.

5. For bookings that map to guarantees that have a unique user based goal with high debt, add appropriate frequency capping, with consideration for the number of other bookings (say across different ad sizes) that contribute to the same goal.

6. For small bookings that are competing with larger ones for the same inventory, adjust priority accordingly.

It is appreciated that these rules may be frequently added to and maintained based on current business needs and observations on how the internal logic of ad server 400 works. It is also appreciated that the above formulation is flexible and can handle a wide variety of goals. For example, some goals may include:

1. Guarantees have lines corresponding to categories of publisher content, for example, sports, with a requirement that 80% of a specified amount of delivery be met. This produces a set of goals for each line and a contribution of 0.8 for delivery from a partition belonging to a purchase made in that category.

2. Guarantees have a requirement on reaching at least a specified number of unique users. This produces a goal for each guarantee and contributions based on the likelihood that an impression from a partition eligible for the guarantee may result in a new user. The translator may also contain rules that correspond to the frequency controls available in the external ad server.

3. A guarantee requires 60% of impressions to be delivered to a specified attribute, such as a demographic of Women, 25-44. This produces a goal with contributions based on the likelihood that a user from a partition is within the desired demographic. This likelihood may be based on external data regarding the publisher that the partition's purchase was made from as well as information of the purchasing system about the specific purchase. For example, some publisher's allow purchases for specific demographics, which would condition the generic data available for the publisher.

4. Customer states a preference for a certain type of inferred attribute, such as a specific ad size, publisher content or time of day. This produces a goal with a contribution of 1.0 for such inventory. This goal is usually given a penalty much lower than standard goals and pacing related penalties.

5. Customer requests uneven delivery over times, for example a heavy-up period during the first half of the campaign. This request is a preference but not guaranteed. This produces a modification of the pacing constraints, the upper limit is relaxed per the customer's guidance but the lower limit of delivery stays the same.

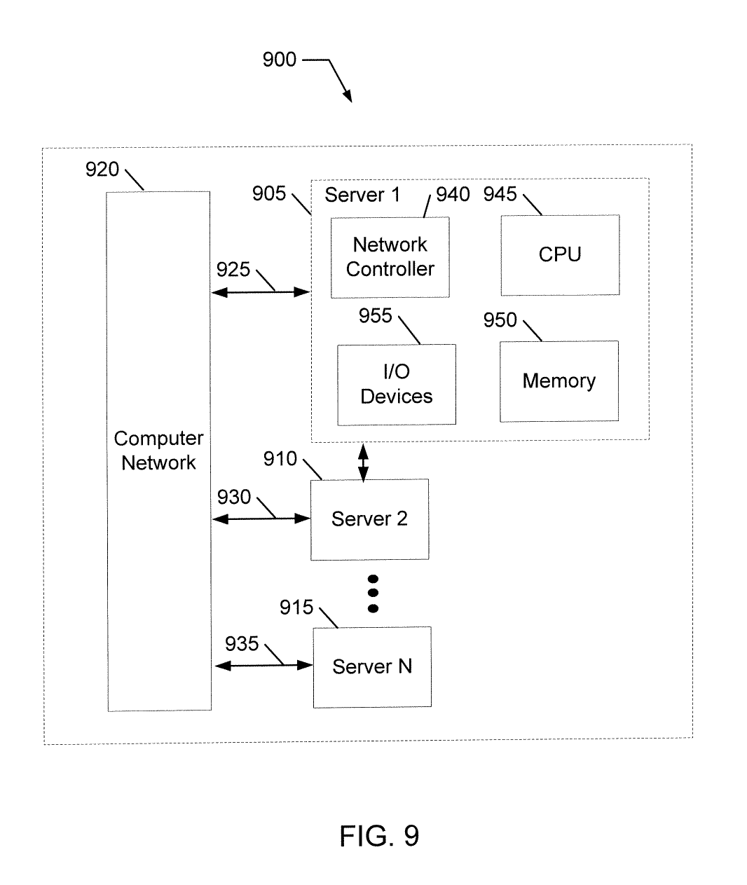

It is appreciated that the ad network system 100 of FIG. 1 and its components and operations described with reference to FIGS. 2-8 can be implemented using computer system 900 shown in FIG. 9. Computer system 900 may include one or more computer servers 905-915 that are connected to computer network 920, e.g., the Internet, via computer buses 925-935. Computer servers 905-915 may be any computer server known to one skilled in the art, and may include components such as network controller 940, CPU 945, memory 950, I/O devices 955 (e.g., keyboard, mouse, touch screen, monitor, printer, and the like, not shown), and so on.

Advantageously, the ad network system of the invention enables advertisers to determine optimize delivery of ad inventory in an ad network using a third-party ad server such that advertising campaigns managed by the ad network have their guarantees met. In particular, ad delivery is seamlessly optimized by the ad network while allowing flexible specification of various campaign qualifiers, constraints, and quality controls.

An embodiment of the present invention relates to a computer storage product with a computer readable storage medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs, DVDs and holographic devices; magneto-optical media; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using JAVA®, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications; they thereby enable others skilled in the art to best utilize the invention and various embodiments with various modifications as are suited to the particular use contemplated. It is intended that the following claims and their equivalents define the scope of the invention.

What is claimed is:

1. An ad network system for optimizing the delivery of online display advertisement inventory, comprising:
an advertiser management system to manage and acquire data for a set of advertising campaigns for a set of advertisers;
a publisher management system to manage and acquire data for inventory at publishers' sites and applications; and
a delivery management system to manage a set of representations of the set of advertising campaigns in a third-party, external ad server in order to meet a set of guarantees for the set of advertising campaigns.

2. The ad network system of claim 1, wherein the data acquired by the advertiser management system comprises a set of requirements, the set of guarantees, qualifiers, quality controls, campaign goals, and delivery data for the set of advertising campaigns.

3. The ad network of claim 2, wherein campaign goals are based on at least one of declared attributes, inferred attributes, and modeled attributes.

4. The ad network system of claim 1, wherein the data acquired by the publisher management system comprises data describing inventory already purchased and inventory that can be purchased from the publishers' sites and applications.

5. The ad network system of claim 1, wherein the third-party ad server provides delivery data by representation to the delivery management system.

6. The ad network system of claim 1, wherein the delivery management system comprises a state that is periodically updated.

7. The ad network system of claim 6, wherein the state comprises a description of the set of representations and a schedule for their modification.

8. The ad network system of claim 1, wherein the delivery management system comprises an optimization module.

9. The ad network system of claim 8, wherein the optimization module comprises routines for determining an optimal allocation set for allocating ads to the set of representations.

10. The ad network system of claim 9, wherein the routines for determining the optimal allocation set comprise linear programming routines.

11. The ad network system of claim 9, wherein the delivery management system comprises a translator to translate the optimal allocation set into instructions for updating the set of representations.

12. The ad network system of claim 11, wherein the instructions comprise instructions to modify prioritization of representation elements.

13. The ad network system of claim 11, wherein the instructions comprise instructions to modify pacing constraints of representation elements.

14. A method for optimizing the delivery of online display advertising in an ad network system using a third-party, external ad server to serve ads, the method comprising:
in the ad network system,
acquiring data for a set of advertising campaigns managed by the ad network system;
acquiring inventory data for publishers' sites and applications in the ad network system;
maintaining a set of representations for the set of advertising campaigns in the third-party, external ad server;
determining an allocation of ads to the set of representations; and
updating the set of representations to meet a set of guarantees for the set of advertising campaigns.

15. The method of claim 14, wherein maintaining the set of representations for the set of advertising campaigns comprises maintaining a set of ad bookings with configurable settings and assignments.

16. The method of claim 15, wherein maintaining the set of representations comprises defining the representations according to a set of restrictions imposed by the third-party, external ad server.

17. The method of claim 16, wherein updating the set of representations comprises applying a set of rules to the allocation of ads, based on the set of restrictions imposed by the third-party, external ad server.

18. The method of claim 14, wherein determining an allocation of ads to the set of representations comprises minimizing an objective function that calculates penalties incurred when the set of guarantees is not satisfied.
